(19) United States
(12) Patent Application Publication
(10) Pub. No.: US 2012/0240045 A1
(43) Pub. Date: Sep. 20, 2012

(54) SYSTEM AND METHOD FOR AUDIO CONTENT MANAGEMENT

(76) Inventors: Nathaniel T. Bradley, Tucson, AZ (US); William C. O'Conor, Potomac, MD (US); David Ide, Scottsdale, AZ (US)

(21) Appl. No.: 13/280,184

(22) Filed: Oct. 24, 2011

Related U.S. Application Data
(63) Continuation-in-part of application No. 13/098,677, filed on May 2, 2011.
Application No. 13/098,677 is a continuation of application No. 11/682,843, filed on Mar. 6, 2007, now Pat. No. 7,966,184.
Application No. 11/682,843 is a continuation-in-part of application No. 12/637,512, filed on Dec. 14, 2009, now Pat. No. 8,046,229.
Application No. 12/637,512 is a continuation of application No. 10/637,970, filed on Aug. 8, 2003, now Pat. No. 7,653,544.
(60) Provisional application No. 60/778,975, filed on Mar. 6, 2006.

(51) Int. Cl. G06F 3/01; G06F 15/16

(52) U.S. Cl. 715/716

(57) ABSTRACT

Audio files representing files intended primarily for viewing (e.g., by sighted users) are created and organized into hierarchies that mimic those of the original files as instantiated at original websites incorporating such files. Thus, visually impaired users are provided access to and navigation of the audio files in a way that mimics the original website.

### CROSS-REFERENCE TO RELATED APPLICATIONS

This application is a CONTINUATION-IN-PART of (i) U.S. patent application Ser. No. 13/098,677, filed May 2, 2011, which is a CONTINUATION of U.S. patent application Ser. No. 11/682,843, filed Mar. 6, 2007, now U.S. Pat. No. 7,966,184, which claims the priority benefit of U.S. Provisional Application No. 60/778,975, filed on Mar. 6, 2006; and (ii) U.S. patent application Ser. No. 12/637,512, filed Dec. 14, 2009, which is a CONTINUATION of U.S. patent application Ser. No. 10/637,970, filed Aug. 8, 1003, now U.S. Pat. No. 7,653,544, which claims the priority benefit of U.S. Provisional Application No. 60/399,892, filed Jul. 31, 2002, all of which are hereby incorporated by reference in their entireties.

### FIELD OF THE INVENTION

Embodiments consistent with this invention relate generally to data processing for the purpose of creating managing and accessing audible content available for use on the web, on mobile phone, and mp3 devices, and enabling any user, but especially visually-impaired and disabled users, to access and navigate the output based on audio cues.

### BACKGROUND

Websites and many other computer files and content are created with the assumption that those who are using the files can see the file content on a computer monitor. Because websites and other content are developed with the assumption that users is visually accessing the content, the sites do not convey much content audibly, nor do the sites convey navigation architecture, such as menus and navigation bars, audibly. The result is that users that are unable to view the content visually or incapable of visually accessing the content have difficulty using such websites.

Conventional systems have been developed to help visually-impaired and other users use websites, but these systems often require software and hardware to be installed at the user's computer. Many of these systems simply use screen reading technology alone or in combination with print magnifying software applications. The systems have shown to be costly, unwieldy, and inconvenient. Furthermore, because such technology is installed on the user's computer, visually-impaired users cannot effectively use conventional computer files anywhere except at their own computers. As a consequence, websites and other computer files are often inaccessible to users anywhere except at home.

Several conventional systems have been developed to overcome this problem by enabling users to access some computer information using any touchtone telephone. In essence, a caller accesses a special computer by telephone. The computer has access to computer files that contain audio components, which can be played back though the telephone to the user. For example, a text file that has been translated by synthetic speech software into an audio file can be played back to the user over the telephone. Some systems access audio files that have already been translated; some translate text-to-speech on the fly upon the user's command. To control which files are played, the user presses the keys on the touchtone keypad to send a sound that instructs the computer which audio file to play.

Unfortunately, these systems also have drawbacks. Large files or those having multiple nesting layers turn the system into a giant automated voice response system, which is difficult to navigate and often very frustrating. Typically only text is played back to the user. Graphics, music, images and navigation systems like those on a website are not. Furthermore, some of the metallic voices of the computer-generated speech does not convey meaning with inflection like a human does, and is tedious to listen to, especially for significant volumes of information.

### SUMMARY

Methods and systems consistent with the present invention provide for the creation of audio files from files created originally for viewing (e.g., by sighted users). Files created originally for primarily sighted-users are referred to herein as original files. An organized collection of original files is referred to herein as an original website. A hierarchy and navigation system may be assigned to the audio files based on an original website design, providing for access to and navigation of the audio files in a way that mimics the navigation of the original website.

In various embodiments the present invention provides systems and methods for distributing audio content. User selections of original content (e.g., Web pages, search queries, etc.) which the user wants to be converted to audio content are received and such a conversion is performed. Identifiers are associated with the original content and the audio content. The identifier and the associated audio content are then stored in a network device for access by one or more users that indicated a desired to access the original content in the audio content form.

### BRIEF DESCRIPTION OF THE DRAWINGS

The accompanying drawings, which are incorporated in and constitute a part of this specification, illustrate an implementation of methods and systems consistent with the present invention and, together with the description, serve to explain advantages and principles consistent with the invention. In the drawings,

FIG. 1 illustrates an internetworks system suitable for use in connection with embodiments of the present invention;

FIG. 2 illustrates an exemplary computer network as may be associated with the internetworked system shown in FIG. 1;

FIG. 3 illustrates an exemplary home page of an original website;

FIG. 4 illustrates an exemplary hierarchy of pages in a website;

FIG. 5 illustrates a keyboard navigation arrangement consistent with embodiments of the present invention;

FIG. 6 illustrates an interaction among components of a computer system and network consistent with embodiments of the present invention;

FIG. 7 illustrates a method for converting an XML feed to speech consistent with one embodiment of the present invention;

FIG. 8 illustrates a method for human-enabled conversion of a web site to speech consistent with one embodiment of the present invention;

FIG. 9 illustrates a method for converting a published web site to speech consistent with one embodiment of the present invention;

FIG. 10 illustrates a method for providing an audio description of a web-based photo consistent with one embodiment of the present invention;

FIG. 11 illustrates a method for converting published interactive forms to speech consistent with one embodiment of the present invention;

FIG. 12 illustrates a method for indexing podcasts consistent with one embodiment of the present invention;

FIG. 13 illustrates an exemplary media player consistent with one embodiment of the present invention; and

FIG. 14 illustrates a computer system that can be configured to perform methods consistent with the present invention;

FIG. 15 illustrates a pictorial representation of a communications environment in accordance with an embodiment of the present invention;

FIG. 16 is a pictorial representation of user environment in accordance with an embodiment of the present invention;

FIG. 17 is a pictorial representation of a computing system in accordance with an embodiment of the present invention.

FIG. 18 is a flowchart of a process for performing audio conversion of original content in accordance with an embodiment of the present invention;

FIG. 19 is a flowchart of a process for performing audio conversion of original content in accordance with an embodiment of the present invention; and

FIG. 20 is a pictorial representation of an audio user interface in accordance with an embodiment of the present invention.

### DETAILED DESCRIPTION

Methods and systems consistent with the present invention create audio files from files created originally for sighted users. Files created originally for primarily sighted-users are referred to herein as original files. An organized collection of original files is referred to herein as an original website. Thus, a hierarchy and navigation system may be assigned to the audio files based on the original website design, providing for access to and navigation of the audio files.

The audio files may be accessed via a user's computer. An indicator may be included in an original file that will play an audible tone or other sound upon opening the file, thereby indicating to a user that the file is audibly accessible. Upon hearing the sound, the user indicates to the computer to open the associated audio file. The content of the audio file is played though an audio interface, which may be incorporated into the user's computer or a standalone device.

The user may navigate the audio files using keystroke navigation through a navigation portal. Unlike the touchtone telephone systems which require an audio input device, embodiments consistent with the present invention may utilize toneless navigation. In one embodiment consistent with the present invention, the user may use voice commands that are detected by the navigation portal for navigation. In yet another embodiment, the user actuates a touch screen for navigation. The navigation portal may be implemented on a computer system, but may also be implemented in a telephone, television, personal digital assistant, or other comparable device.

Reference will now be made in detail to an implementation consistent with the present invention as illustrated in the accompanying drawings.

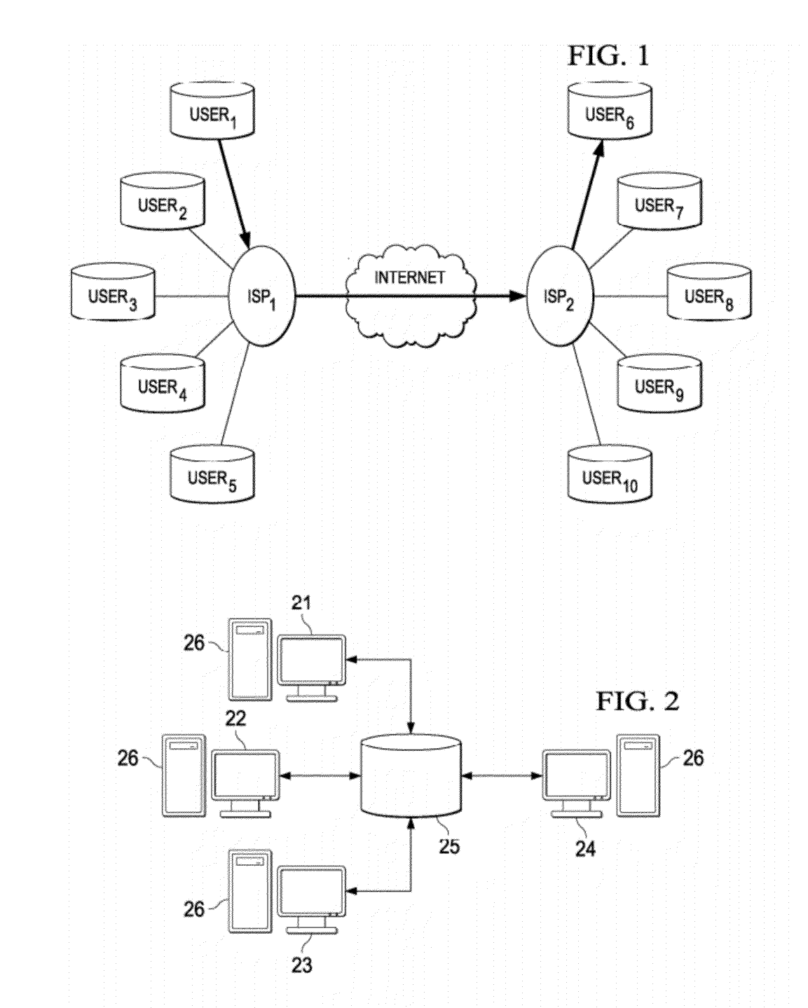

One embodiment consistent with the present invention may be applied to original web pages hosted on remote computers of a global computer network, for example, the Internet. FIG. 1 illustrates a plurality of users' computers, indicated as userᵢ . . . userₓ, communicating with each other through remote computers networked together. Another embodiment consistent with the present invention may be used for smaller computer networks, such as local area or wide area networks. FIG. 2 illustrates such a network, where a plurality of users' computers, 21, 22, 23 and 24 communicate through a server 25. In this example, each user's computer may have a standalone audio interface 26 to play audio files. Alternatively, the audio interface could be incorporated into the users' computers.

In one embodiment consistent with the present invention, audio files may be created by converting text, images, sound and other rich media content of the original files into audio files through a site analysis process. In this embodiment, a human reads the text of the original file and the speech is recorded. The human also describes non-text file content and file navigation options aloud and this speech is recorded. Non-speech content, such as music or sound effects, is also recorded, and these various audio components are placed into one or more files. Any type of content, such as but not limited to FLASH, HTML, XML, .NET, JAVA, or streaming video, may be described audibly in words, music or other sounds, and can be incorporated into the audio files. A hierarchy is assigned to each audio file based on the original computer file design such that when the audio file is played back through an audio interface, sound is given forth. The user may hear all or part of the content of the file and can navigate within the file by responding to the audible navigation cues.

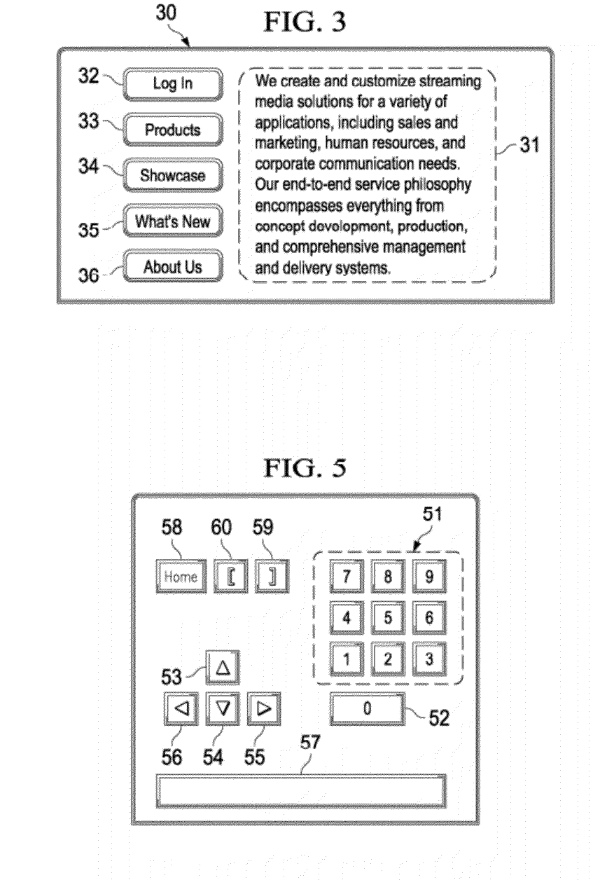

In this embodiment, an original website is converted to an audible website. Each file, or page, of the original website is converted to a separate audio file, or audio page. The collection of associated audio files may reside on a remote computer or server. For example, FIG. 3 illustrates the home page 30 of an original website. A human reads aloud the text content 31 of the home page 30 and the speech is recorded into an audio file. The human says aloud the menu options 32, 33, 34, 35, 36 which are “LOG IN”, “PRODUCTS”, “SHOWCASE”, “WHAT'S NEW”, and “ABOUT US”, respectively, that are visible on the original website. This speech is also recorded.

Similarly, a human reads aloud the text content and menu options of other files in the original website and the speech is recorded into audio files. In this example, key 1 is assigned to menu option 32, LOG IN; key 2 is assigned to menu option 33, PRODUCTS; key 3 is assigned to menu option 34, SHOWCASE; key 4 is assigned to menu option 35, WHAT'S NEW; key 5 is assigned to menu option 36, ABOUT US. Other visual components of the original website may also be described in speech, such as images or colors of the website, and recorded into one or more audio files. Non-visual components may also be recorded into the audio files, such as music or sound effects.

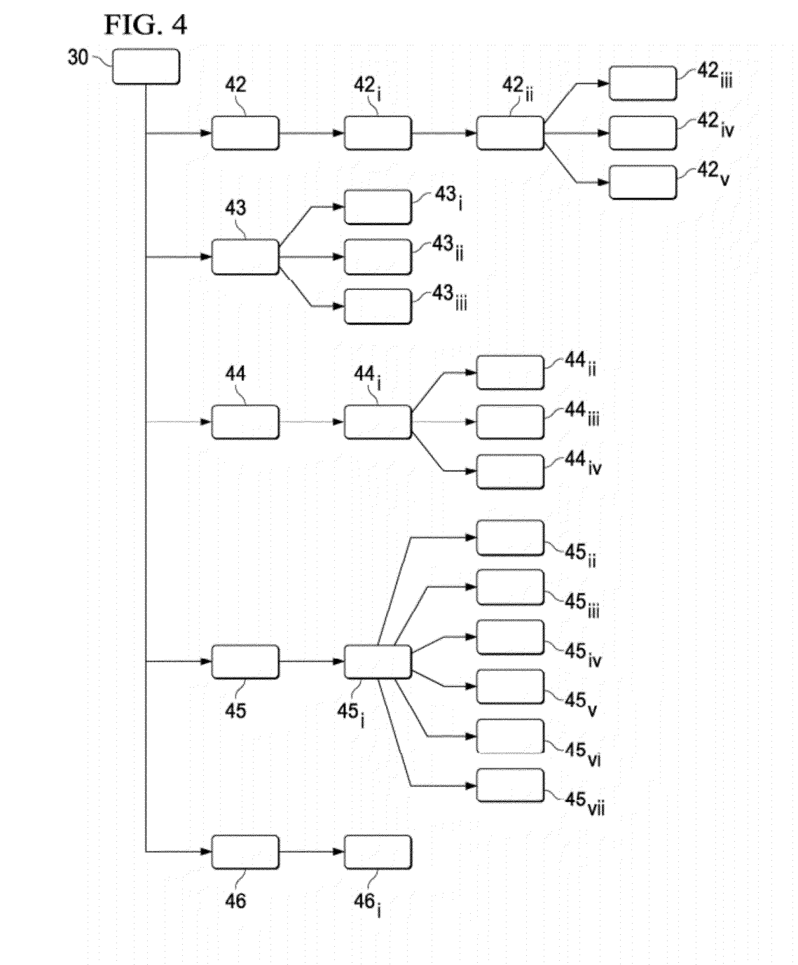

FIG. 4 shows an exemplary hierarchy of the original files which form the original website 40. Menu option 32 will lead to the user to file 42, which in turn leads to the files 42ᵢ . . . v. Menu option 33 will lead to the user to file 43, which in turn leads to the files 43ᵢ . . . . iii. Menu option 34 will lead to the user to file 44, which in turn leads to the files 44ᵢ . . . iv, similarly for all the original files of the original website. The collection of audio files will follow a hierarchy substantially similar to that shown in FIG. 4 to form an audible website which is described audibly.

In one embodiment consistent with the present invention, text is inputted into a content management system (CMS) and automatically converted to speech. Upon acquisition of the text, a third party text-to-speech engine, such as AT&T Natural Voices or Microsoft Reader, is invoked and an audio file, such as a .wav file, or .mp3 file is created. The audio file may be encoded according to a standard specification, such as a standard sampling rate. Once encoded, the audio file is uploaded to a Content Delivery Network (CDN) and a URL path is established for content access. The URL path of the audio content is associated with a navigation value in a navigation database. During browsing, a user selection having a navigation value is mapped to an audio content URL using the navigation database. The audio content is then acquired and played on the client system.

In another embodiment consistent with the present invention, syndicated web site feeds are read and structured information documents are converted into audio enabled web sites. In one example, the syndicated web site feed is a Really Simple Syndication (RSS) and the structure information document is an XML file. An RSS URL is first entered into the CMS. An RSS scraping logic is entered into the content management system and upon predefined schedule, an RSS content creation engine is invoked. The RSS content creation engine extracts the content titles, descriptions, and order from the feed following the RSS structure provided from the feed. The URL path to the story content is deployed into a scraping engine and the text is extracted using the scraping logic. The content is then filtered to remove all formatting and non-contextual text and code.

A text-to-speech conversion is completed for both titles and main story content. The converted titles and content, now in an audio format such as a .wav file, are uploaded to a CDN and a URL path is established for content access. The URL path of the audio content is associated with a navigation value in a navigation database. During browsing, a user selection having a navigation value is mapped to an audio content URL using the navigation database. The audio content is then acquired and played on the client system. Through XML integration, the content is displayed in text within a media player and when selected using keystrokes or click through the file is played over the web.

The structure of a sample RSS feed file is given below:

```
<?xml version=“1.0” encoding=“UTF-8” ?>
<rss version=“2.0” xmlns:blogChannel=
“http://backend.userland.com/blogChannelModule”>
<channel>
    <title> </title>
    <link> </link>
    <description />
    <language> </language>
    <copyright> </copyright>
    <generator>XML::RSS<generator>
    <ttl><ttl>
<image>
    <title> </title>
    <url> </url>
    <link> </link>
    </image>
<item>
    <title> </title>
    <link> </link>
    <description> description>
    <category> </category>
    <guid isPermaLink=“false”> </guid>
    <pubDate> </pubDate>
</item>
    </channel>
    <rss>
```

Note that a feed file may have multiple <item> tags. Each <item> tag has child tags that provide information about the item. The <title> tag is the tag the system reads and uses when it attempts to determine if an item has changed since it was last accessed. A user creating or editing menus may have the option of selecting RSS as one of the content types. The sequence of events that will eventually lead to menu content creation if the user chooses RSS as a content type are as follows: Menu creation; Reading; Scraping; Filtration; Audio generation; and XML generation.

The Menu Name, Feed Location and the Advanced Options fields are available if the RSS Feed option is selected in the Content Type field. Clicking a Browse button in the Menu Name Audio field may launch a dialog box to let the user select an audio file. Clicking a Save button will save the details of the new menu in the system. The new menu will be in queue for generating the audio for the respective items. The system runs a scheduler application that initiates TTS conversion for menus. This scheduler may also initiate the pulling of the feed file. Thereafter, control will move to the Reading Engine. Clicking a Cancel button will exit the page. The scheduler application and reading engine are described below.

In one embodiment consistent with the present invention, a navigation portal may include a keyboard having at least eighteen keys. As illustrated in FIG. 5, the keys may include ten numbered menu-option keys, four directional arrow keys, a space bar, a home key, and two keys for volume adjustment. The volume keys may be left and right bracket keys. The navigation system may be standard across all participating websites and the keys may function as follows:

the keys numbered 1 though 9 select associated menu options 51;

the key numbered 0 selects help 52;

the up arrow selects forward navigation 53;

the down arrow selects backward navigation 54;

the right arrow key selects the next menu option 55;

the left arrow key selects the previous menu option 56

the spacebar repeats the audio track 57;

the home key selects the main menu 58;

the right bracket key increases the volume of the audible website 59;

the left bracket key decreases the volume of the audible website 60.

The keys may be arranged in clusters as shown in FIG. 5, using a standard numeric 10-key pad layout, or use alternative layouts such as a typewriter keyboard layout or numeric telephone keypad layout. Other types of devices may be used to instruct computer navigation. For example, for users who are not dexterous, a chin switch or a sip-and-puff tube can be used in place of a keyboard to navigate the audible websites.

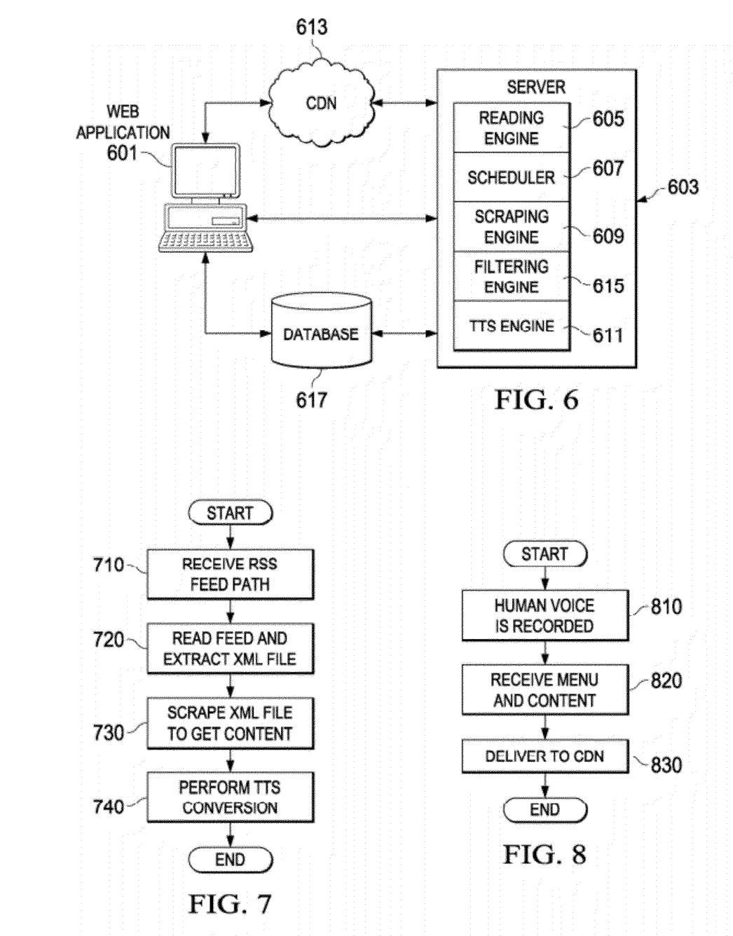

FIG. 6 illustrates an interaction among components of one embodiment consistent with the present invention. Web application 601 provides a web-based portal through which users may interact with systems consistent with the present invention. Uploaded audio files, XML data files and RSS feeds are provided to server 603 via web application 601. Server 603 includes a reading engine 605 for reading RSS feeds, a scheduler application 607 for scheduling the reading of RSS feeds, a scraping engine 609 for scraping XML and web page source code, a filtering engine for filtering scraped content, and a text to speech (TTS) engine 611 for converting text-based web content to audio content. Server 603 provides audio content to the Content Delivery Network (CDN) 613, which can then provide content to a user through web application 601. Server 603 further provides XML data files to a database 617 for storage and retrieval.

The reading engine 605 is invoked at regular intervals by the scheduler 607 application on the server 603. It pulls the feed file and parses it to assemble a list of items syndicated from the feed URI specified. The first time the feed file is pulled from its URI, the reading engine 605 inspects it and prepare a list of items in the file. These items are created as submenus under the menu for which the feed URI is specified (here onwards, the “base menu”).

If this file has previously been read and parsed, each item (i.e., the <item> tag's content) are compared with the submenu at the respective position under the base menu. If the titles do not match, the system may assume that the item has changed and will mark the new item, as a candidate for scraping and the existing item would be removed. In one embodiment, items are compared like this one at a time. Once the items have been compared, this engine hands over control to the scraping engine 609.

The scraping engine 609 accepts the list of items marked for scraping by the reading engine 605. It reads one at a time, the actual links (URLs) to content pages for these items and performs an actual fetch of the content from those pages. This content may be acquired “as is” from the pages. This content is then handed on to the filtering engine 615. The content handed over by the scraping engine 609 may be raw HTML content. The raw HTML content could contain many unclean HTML elements, scripts, etc. These elements are removed by the filtering engine 615 to arrive at human-understandable text content suitable for storage in the menu system as Menu content text. The filtering engine 615 thus outputs clean content for storage in the system's menus. This content is then updated for the respective menus in the system as content text. The menus that are updated will become inactive (if not already so) and will be in queue for content audio generation.

Audio is generated for the updated content in the menus that have been updated by RSS feeds at the closest audio generation sequence executed by the TTS engine 611. Finally XML Data files may be generated/updated with the new menu name, content and audio file name/path. These XML files may be used by a front-end flash application to display the Menu, Content or to play the Audio. An indicator is included in an original website that activates a tone upon a user's visit indicating that the website is audibly accessible. Upon hearing the tone, a user presses a key on his keyboard and enters the audible website. The original website may close or remain open. The user may then navigate the audible website using a keystroke command system. Audible narration is played through an audio interface at the user's computer, describing text and menus and indicating which keystrokes to press to listen to the other audio web files with in the audible website. Users may thus navigate website menus, fast forward and rewind content, and move from website to website without visual clues.

FIG. 7 is a flow chart illustrating a method for converting an XML feed to speech consistent with one embodiment of the present invention. An RSS XML feed is entered in a web application (step 710). The XML/RSS path is read by a content management system and text content is extracted from the feed, indexed into menus, and associated with a web-based content URL (step 720). For each menu item created, servers create an association with a web page and a scrape logic that provides coordinates for source code text extraction, extract the text, filter the text to remove source code references, and then forward the filtered text to the TTS engine (step 730). The TTS engine is then invoked and creates a sound file that is transferred to the CDN, and XML data for the web application is stored as a node in the database (step 740).

FIG. 8 is a flow chart illustrating a method for human-enabled conversion of a web site to speech consistent with one embodiment of the present invention. First, a human voice is recorded from any digital device or desktop application (step 810). A user then uploads menu and content files through an administration panel, and content is converted to an .mp3 file format, indexed, and associated with the intended database content and menu nodes (step 820). One of ordinary skill in the art will recognize that the content may be converted to any existing or future-developed sound file format. The resulting content is delivered to the CDN for delivery to other users, to the database as a URL and text-based label, and to the web application as XML data for navigation (step 830).

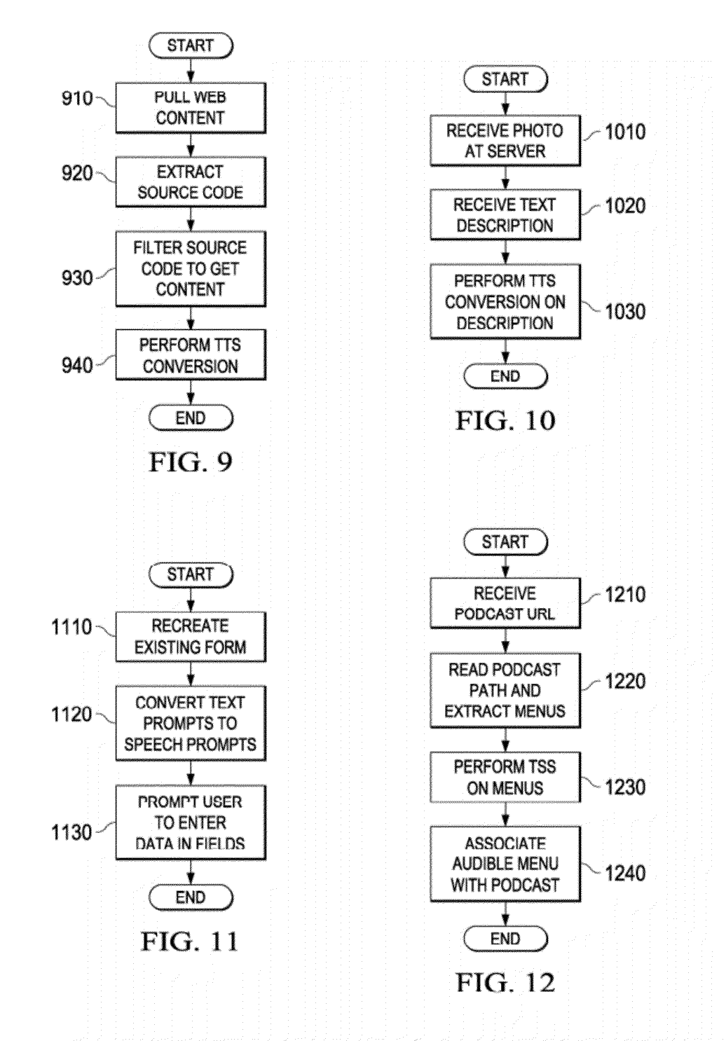

FIG. 9 is a flow chart illustrating a method for converting a published web site to speech consistent with one embodiment of the present invention. Website content is pulled through a browser on a preset schedule (step 910). The source code is read by a content management system and text content is extracted from the source code, indexed into menus, and associated with a web-based content URL (step 920). For each menu item created, servers create an association with a web page and a scrape logic that provides for source code text extraction, extract the text, filter the text to remove source code references, and then forward the filtered text to the TTS engine (step 930). The TTS engine is then invoked and creates a sound file that is transferred to the CDN, and XML data for the web application is stored as a node in the database (step 940).

FIG. 10 is a flow chart illustrating a method for providing an audio description of a web-based photo consistent with one embodiment of the present invention. A photo is saved to the server via the web-based application (step 1010). A text description of the photo is then uploaded via the web application (step 1020). Alternatively, a user may upload a voice description of the photo via the web application. The text description of the photo is then sent to the TTS engine, which creates an audible description of the photo and uploads the description to the CDN (step 1030).

FIG. 11 is a flow chart illustrating a method for converting published interactive forms to speech consistent with one embodiment of the present invention. An existing web-based form is recreated using text inputs in the web application (step 1110). The text is forwarded to the TTS engine, which creates audible prompts for various fields in the web-based form (step 1120). An end user then accesses the audible form and enters data into the fields according to the audio prompts (step 1130).

FIG. 12 is a flow chart illustrating a method for indexing podcasts consistent with one embodiment of the present invention. A URL for a podcast is entered via the web application (step 1210). The podcast URL path is read by the servers and text menu names are created from the feed, indexed into menus, and associated with the content URL (step 1220). The TTS engine is invoked and the menu item content is converted into an audible content menu (step 1230). The audible content menu is then delivered to the CDN and XML is created to point to the podcast from the web application (step 1240).

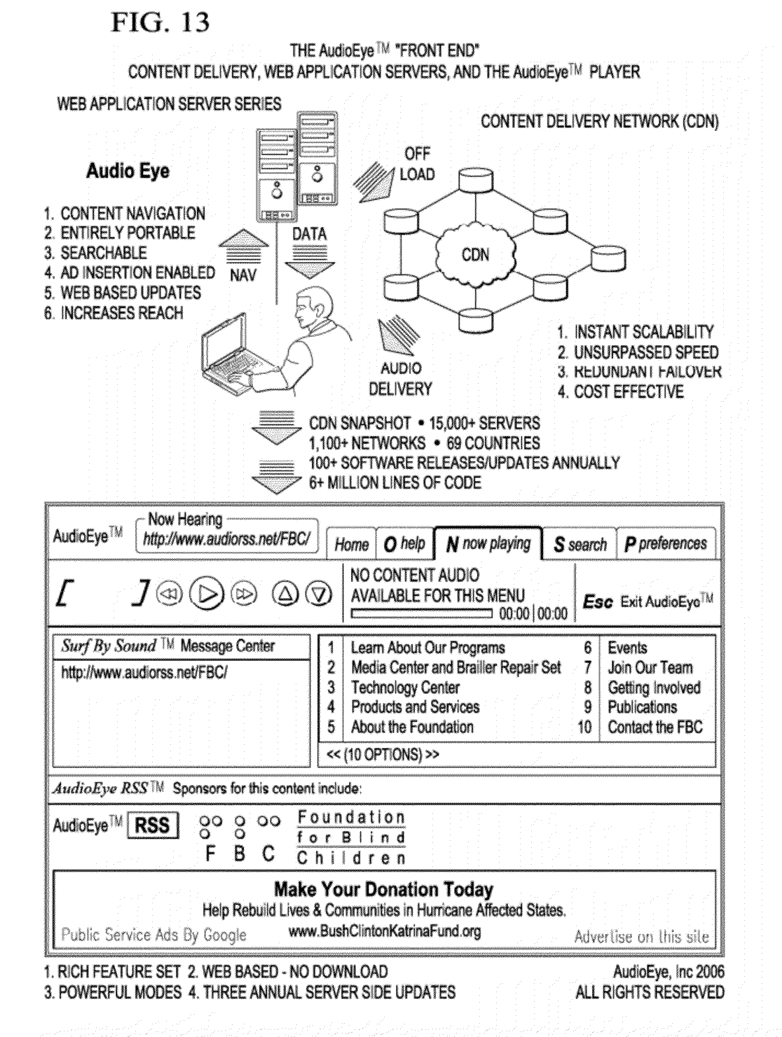

FIG. 13 illustrates an exemplary media player consistent with one embodiment of the present invention. A media player consistent with an embodiment of the present invention is now described. At any point the end user has the option of pressing ‘Home’ to return to the main menu, ‘#’ for the help menu, ‘N’ for the now playing view, ‘S’ to Search, ‘P’ for the preferences menu. N now playing is the selected tab, which displays volume control, playback controls (play is highlighted orange (#FF8737) because this sample view assumes an audio track is being played. If not playing a highlighted pause button should display. Likewise, if the arrow keys are—‘right, left, up, down’—or the audio controls—‘[’ or ‘]’—are pressed, the button is intended to highlight orange.) To the right of these controls may be the Player Status area, which displays the metadata for the audio file. If playing, ‘Playing’ displays. Other play states should include ‘Buffering’, ‘Paused’, ‘Stopped’. The player may also display the bit-rate at which the audio track is playing (if possible). Next, it displays the Track Title Name (this should only display a given # of characters and if the title of the track is longer than the maximum # of characters, the title should be truncated and followed by three periods Below this a reader may see a navigation bar that displays the 0-100 value of the audio track playing. Lastly, a reader may see a current track time display and the total audio track time display. The Esc button (which, again, would highlight if pressed) is provided to allow the user to exit the player and return to the normal website.

Below the N now playing tab, there may be Surf by Sound Message Center, which provides simple text cues. Also, if the end user has Subtitles turned on, this is where the text being read would be displayed. To the right of the message center may be the navigation choices In a grey area of the nav selection, there may be ‘/more navigation info ([number] of options)’ text. This helps the user follow the path of their navigation. For example if on a homepage with 6 menu options, this are would display ‘(/home (6 options)’. Further if an end-user chose the 5th menu option (e.g. News & Events) which, for perhaps had 12 menu options, the navigation listing would update and the text area would now display ‘/News & Events (12 options)’. If there are 12 menu options, the ‘more selections >>’ text would appear more prevalently and the end user would have the option of seeing what those options are by clicking the button (which, again, would make the button highlight orange). Likewise, if there were more than 10 options for any given menu, the navigation listing may automatically advance and display 6-10 in the nav box on the left, 11-15 on the right, etc.).

The search view assumes the end user pressed S from within the default view (see above). Before searching, the audio menu may allow the end user to choose whether they want to search the current site they are on or the a Surf by Sound Portal, which, if selected, would direct the user to the surf by sound portal. Once selected, they would then automatically be cued up to begin typing their search request. If Audio Key Playback is on, a reader may hear their key strokes. Also, a reader may see that the Message Center displays helpful text description of what they are doing (i.e. it coincides with the general text being read). And the ‘/search (2 options)’ text is displayed since they are on the search tab and there are 2 options to choose from. Lastly, pressing ‘E’ (which would trigger the highlighted orange) within either the Search or Preferences Menu would Exit the menu and return to the default view.

The preferences view assumes that the user pressed P from within the default view. First, this tab displays the Bandwidth of the user's machine this is an automatically generated test that was conducted when the first opened the player. From within this view the Message Center is updated with information pertaining the general process being described via audio and the nav options coincide with the options from within this preferences tab. The first option is to turn ‘Subtitles’ On or Off. If on, the media player displays the text being read in the message center display box. The other options within this tab would be turning on or off ‘Screen Reader Mode’, ‘Audio Key-Press’, and Magnify Mode'. Lastly, it may also give the user the option of displaying the default view or the ‘Player Only’. ‘Player Only’ display would get rid of (hide) the message center and navigation options boxes.

An embodiment consistent with the present invention may include a control panel to let the administrator manage third party sites. The user may have access to a Manage 3rd Party Sites link in the administration panel under Site Management menu. The administrator may sort the grid on Site Name, Site Contact and Create Date. Clicking a site name may move control to the menu management section for a particular third party site. Control moves to MANAGE THIRD PARTY MENUS. Clicking a site URL may bring up the home page of the site in a new browser window. This page may display a media player for the third party site. Clicking an icon may move control to CREATE THIRD PARTY SITE. Fields prefixed with “*” are required fields. The Username and E-mail must be unique in the system. Clicking the Create button creates the new account. An e-mail may be sent to the administrator's account. Control then moves to the previous page. Clicking the Cancel button unconditionally exits the page. Clicking the Back button moves control to the previous page.

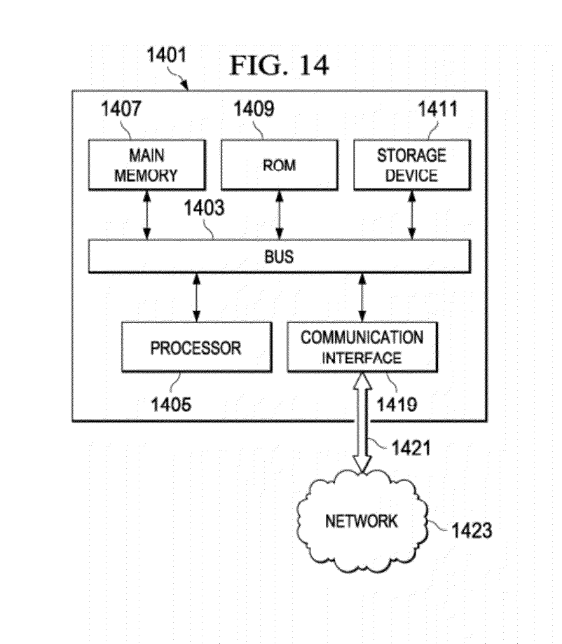

Turning to FIG. 14, an exemplary computer system that can be configured as a computing system for executing the methods as previously described as consistent with the present invention is now described. Computer system 1401 includes a bus 1403 or other communication mechanism for communicating information, and a processor 1405 coupled with bus 1403 for processing the information. Computer system 1401 also includes a main memory 1407, such as a random access memory (RAM) or other dynamic storage device, coupled to bus 1403 for storing information and instructions to be executed by processor 1405. In addition, main memory 1407 may be used for storing temporary variables or other intermediate information during execution of instructions to be executed by processor 1405. Computer system 1401 further includes a read only memory (ROM) 1409 or other static storage device coupled to bus 1403 for storing static information and instructions for processor 1405. A storage device 1411, such as a magnetic disk or optical disk, is provided and coupled to bus 1403 for storing information and instructions.

According to one embodiment, processor 1405 executes one or more sequences of one or more instructions contained in main memory 1407. Such instructions may be read into main memory 1407 from another computer-readable medium, such as storage device 1411. Execution of the sequences of instructions in main memory 1407 causes processor 1405 to perform the process steps described herein. One or more processors in a multi-processing arrangement may also be employed to execute the sequences of instructions contained in main memory 1407. In alternative embodiments, hard-wired circuitry may be used in place of or in combination with software instructions. Thus, embodiments are not limited to any specific combination of hardware circuitry and software.

Further, the instructions to support the system interfaces and protocols of system 1401 may reside on a computer-readable medium. The term “computer-readable medium” as used herein refers to any medium that participates in providing instructions to processor 1405 for execution. Common forms of computer-readable media include, for example, a floppy disk, a flexible disk, hard disk, magnetic tape, a CD-ROM, magnetic, optical or physical medium, a RAM, a PROM, and EPROM, a FLASH-EPROM, any other memory chip or cartridge, or any other medium from which a computer can read, either now or later discovered.

Computer system 1401 also includes a communication interface 1419 coupled to bus 1403. Communication interface 1419 provides a two-way data communication coupling to a network link 1421 that is connected to a local network 1423. Wireless links may also be implemented. In any such implementation, communication interface 1419 sends and receives signals that carry digital data streams representing various types of information. The illustrative embodiments may be utilized across a number of computing and communications platforms. It is important to note that audio files may be useful to any number of users or consumers and is not focused on one particular group, type of disability or applicable user. In particular, the illustrative embodiments may be useful across wireless and wired networks, as well as standalone or networked devices.

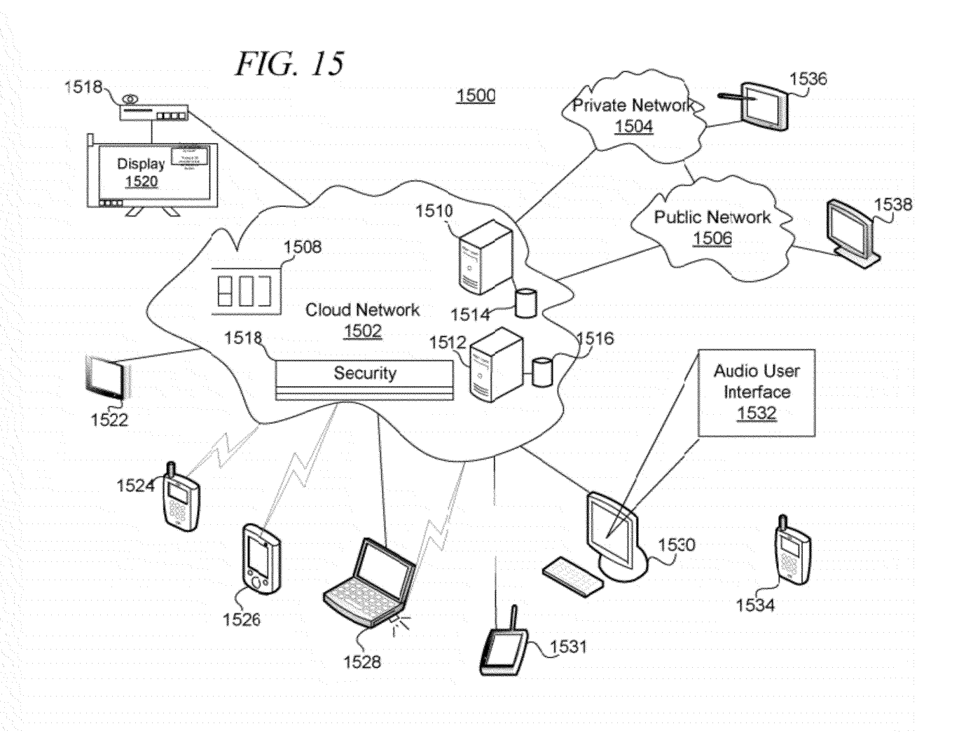

Turning now to FIG. 15 illustrating a communications environment 1500 in accordance with an illustrative embodiment. The communications environment 1500 includes any number of networks, devices, systems, equipment, software applications, and instructions that may be utilized to both generate, playback, and manage audio content. In one embodiment, the communications environment 1500 includes numerous networks. For example, the communications environment 1500 may include a cloud network 1502, a private network 1504, and a public network 1506. Cloud networks are well-known in the art and may include any number of hardware and software components.

In addition, the cloud network 1502 may be accessed in any number of ways. For example, the cloud network 1502 may include a communications management system 1508, servers 1510 and 1512, databases 1514 and 1516, and security 1518. The components of the cloud network 1502 represent multiple components that may be utilized to manage and distribute original content and audio files to any number of users, systems, or other networks. For example, the servers 1510 and 1512 may represent one or more distributed networks and likewise the databases 1514 and 1516 may represent distinct or integrated database management systems and repositories for storing any type of files, data, information, or other content that may be distributed and managed by the cloud network 1502. In addition, the cloud network 1502 may be accessed directly by any number of hard wired and wireless devices.

The security 1518 may represent any number of hardware or software constructs that secure the cloud network. In particular, the security 1518 may ensure that users are authorized to access content or communicate through the cloud network 1502. The security 1518 may include any number of firewalls, software, security suites, remote access systems, network standards and protocols, and network tunnels for ensuring that the cloud network 1502 as well as or in addition to communications between the devices of the communications environment and the cloud network 1502 are secure.

The devices of the communications environment 1500 are representative of any number of devices, systems, equipment, or software that may communicate with or through the cloud network 1502, the private network 1504, and the public network 1506. Developing forms of hardware devices and software may also communicate with these networks as required to access and manage audio files and other audio content. In one embodiment, the cloud network 1502 may communicate with a set-top box 1518, a display 1520, a tablet 1522, wireless devices 1524 and 1526, a laptop 1528 a computer 1530, and a global positioning system (GPS) 1531. A tablet 1536 is representative of any number of devices that may access the private network 1504.

An audio user interface 1532 may be utilized by the computer 1530 or any of the devices in communication with the cloud network 1502 to allow user interaction, feedback and instructions for managing, generating and retrieving audio content as herein described. Stand-alone device 1534 represents a device that may be disconnected from all communications networks for selectively connecting to a network based on needs or selections of a user. The components of the communications environment 1500 together or separately may also function as a distributed or peer-to-peer network for storing audio files, indices of the audio files, and pointers, links, or identifiers for the audio files (and corresponding original files as needed).

The private network 1504 represents one or more networks owned or operated by private entities, corporations, individuals, governments or groups that is not entirely accessible to the public. For example, the private network 1504 may represent a government network that may distribute selective content to users such as the private network of a congressman, senator or state governor's office. The private network 1504 may alternatively be a corporate network that is striving to comply with applicable laws and regulations regarding content made available to employees, clients, and consumers. For example, federal requirements may stipulate that general employee information be available audibly as well as textually.

The public network 1506 represents any number of networks generally dedicated or available to the public, such as the Internet as a whole. As is known in the art, the public network 1506 may be accessible to any number of devices, such as a computer 1538. The communications environment 1500 illustrates how original files may be retrieved for conversion to audio files and distributed through any number of networks and systems to users that require or may utilize the audio files.

In one embodiment, devices may exchange content through a home network. In one embodiment, the audio content may be generated or converted utilizing the laptop 1528 and then subsequently distributed to the wireless device 1524, GPS 1531, and computer 1530. Alternatively, the user may distribute original content for conversion to audio content utilizing a network of friends or family that are willing to record the audio content. As a result, the generation of audio content may benefit from the same social systems and networks available to users that communicate through textual and graphical content.

In one example, a user may send a request for content to be transcribed and described automatically or by a family member, friend, paid transcriptionist, or other party. Next, a volunteer or the selected party retrieves the content by selecting a link, opening a file, or otherwise accessing the content. The content is then transcribed into audio content as described herein for use by the user. The audible content may then be distributed through the social network for the benefit of any number of users using features such as share, like, forward, communicate, or so forth. In one example, a family letter may be transcribed and shared so that other family members may listen to the letter while driving or away from a visual display.

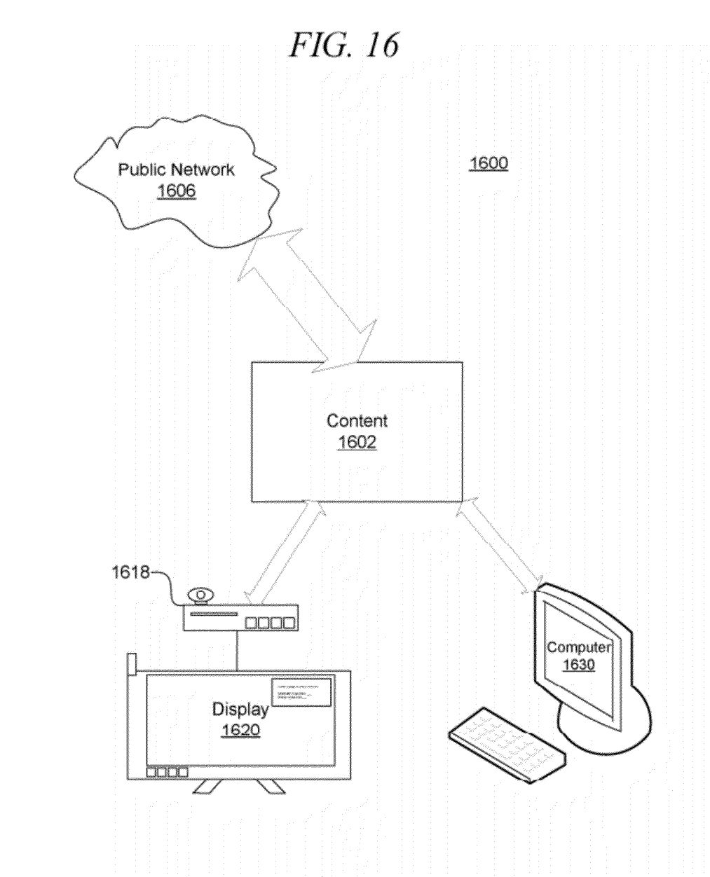

Turning now to FIG. 16, illustrating a user environment 1600 in accordance with an illustrative embodiment. FIG. 16 further describes the public network 1506, set-top box 1518, display 1520 and computer 1530 as selectively combined from FIG. 15. The user environment 1600 may be utilized to send and receive content 1602 which represents original files, converted files, audio files, or other typical communications of the user environment 1600.

In one embodiment, the illustrative embodiments may be utilized to distribute the content 1602 that may be utilized for audio, video, or enhanced closed captioning for media content distributed to the set-top box 1618. The set-top box 1618 may represent any number of digital video recorders, personal video recorders, gaming systems, or other network boxes that are or may be utilized by individual users or communication service providers to manage, store and communicate data, information and media content. In addition to the known media applications and functionality, the set-top box 1618 may also be utilized to browse the Internet, utilize social networking applications, or otherwise display text and graphic content that may be converted to audio content.

In one embodiment, the set-top box 1618 may be utilized to stream the content 1602 in real-time. The real-time content may include original files that may need to be converted to audio content for access by a user. The content 1602 may be displayed to the display 1520 or any number of other devices in communication with the set-top box 1518 or a home network. For example, the set-top box 1618, computer 1630 and other computing and communications devices may communicate one with another through a home network. The home network may communicate with the public network 1606 through a network connection such as a cable connection, fiber optic connection, DSL line, satellite, interface or any number of other links, connections or interfaces.

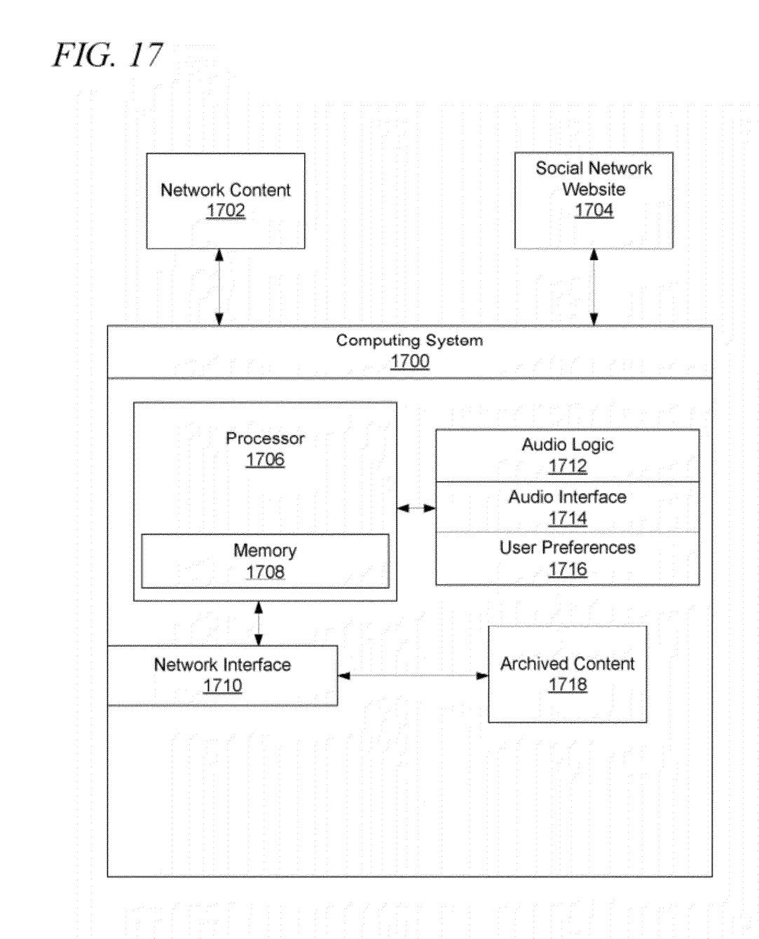

Turning now to FIG. 17 illustrating a computing system 1700 in accordance with an illustrative embodiment. The computing system 1700 illustrates any number of the commercial or user devices of the communications environment 1500 of FIG. 15. The computing system 1700 may send and receive network content 1702 which represents original files, retrieved network content and audio files that are sent and received from the computing system 1700. The computing system 1700 may also communicate with one or more social network websites including a social network website 1704. The social network website 1704 represents one or more social networking, applications, or e-mail or collaborative websites with which the computing system 1700 may communicate.

In one embodiment, the network content 1702 represents search results and ranking performed by a search engine. The network content 1702 may be the search results and rankings that are converted into audio content. For example, automatic text conversion may be performed as the search results are requested. Alternatively, popular searches may be converted daily and read by a human for association with each of the search results.

In another embodiment, the network content 1702 is an electronic coupon or promotional offer, e-commerce website, or global positioning or navigation information. For example, the content generator may associate audio content with an electronic coupon to reach additional consumers. The electronic coupon may be distributed as only text and graphics based or may be grouped with audio content for the electronic coupon. In another example, navigation instructions (i.e. driving instructions from point A to point B) may be converted to one or more audio files associated with individual components or instructions. Media providers, communications service providers, advertisers, and others may find that by making audio content available they are able to attract more diverse clients, consumers, and interested parties.

In one embodiment, the audio interface 1704 of the computing system 300 may be utilized to generate audio content. A user willing to speak or transcribe portions of original content and associate the generated audio files with the selected portions of original content. In one embodiment, the conversion may be performed graphically. For example, a user may utilize a mouse and mouse pointer to hover over designated portions and then may select a button to record audio content with the designated portions. Additionally, the described navigation systems and interfaces may also be utilized to generate the audio content and associate the audio content with the corresponding portions of the original content.

The original content may have been automatically converted to a hierarchical format as previously described before the user associate spoken content with the designated portions of the original content. Alternatively, the user may graphically prepare the hierarchical formatting before performing conversion of the content to audio content. Each search result may be highlighted by a user and then once highlighted a voice command to record or a selection of the keyboard may enable a microphone to record the user speaking the highlighted content. In one embodiment, the system may automatically select or group portions or content of a website, search results, document, or file for selection and a recording conversion by a user.

The computing system 1700 may include any number of hardware and software components. In one embodiment, the computing system 1700 includes a processor 1706, a memory 1708, a network interface 1710, audio logic 1712, an audio interface 1714, user preferences 1716 and archived content 1718.

The processor is circuitry or logic enabled to control execution of a set of instructions. The processor may be microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory is a hardware element, device, or recording media configured to store data for subsequent retrieval or access at a later time. The memory may be static or dynamic memory. The memory may include a hard disk, random access memory, cache, removable media drive, mass storage, or configuration suitable as storage for data, instructions, and information. In one embodiment, the memory and processor may be integrated. The memory may use any type of volatile or non-volatile storage techniques and mediums.

The audio logic 1712 may be utilized to perform the conversions and management of audio files from original files as herein described. In one embodiment, the audio logic 1712 includes a field programmable gate array, Boolean logic, firmware or other instructions that may be updated periodically to provide enhanced features and improved audio content generation functionality. The user preferences 1716 are the settings and selections received from the user for managing the functionality and actions of the audio logic 1712 and additionally the computing system 1700.

In one embodiment, the user preferences 1716 may be stored in the memory 1708. The archived content 1718 may represent audio content previously retrieved or generated by the computing system 1700. The archived content 1718 may be stored for subsequent use by a user of the computing system 1700 and additionally may be accessed by one or more devices or systems or connections that communicate with the computing system 1700 such that the computing system 1700 may act as a portion of a distributed network. As a result, network resources may be shared between any number of devices. The archived content 1718 may represent one or more portions of the memory 1708 or other memory systems or storage systems of the computing system 1700.

The archived content 1718 may store content that was downloaded to the computing system 1700. The archived content 1718 may also store content that was generated on the computing system 1700. In one embodiment, feeds, podcasts or automatically retrieved media content may be stored to the archived content 1718 for consumption by a user when selected.

In one embodiment, the computing system 1700 interacts with the social network website 1704 to generate and make available audio files. For example, a homepage or wall of a user may typically include text, pictures and even video content. The computing system 1700 and social network website 1704 may communicate to ensure that all of the user's content on the social network website 1704, as well as content retrieved by the user, is available in audio form. For example, the social network website 1704 may create a mirror image of the website that includes audio content for individuals that prefer to browse or listen to the content instead of traditional sight based dealing. In one example, the user may be driving and may select to hear comments to a particular posting rather than reading them. As a result, the audio files may be converted by either the social network website 1704 or the computing system 1700 for playback to the user through speakers that may be part of the audio interface 1714 of the computing system 1700.

In another embodiment, the user may select to post content to the social network, blogging, or micro-blogging site audibly. For example, the user may utilize voice commands received through a wireless device, to navigate the social networking site and leave a comment. In one embodiment, a specialized application executed by the wireless device may be configured to receive the users voice for posting, generate an automatically synthesized version of the user's voice, or a default voice for creating the posting. The comment may also be converted to text for those users of the social network that prefer to navigate the site. The specialized key assignments herein described may be utilized to provide the commands or instructions required to manage, generate, and retrieve content from the social networking site. The effect of the social network may be enhanced by being able to access audio content that sounds like the voice of the generating, or posting party.

All of the functionality, features, and content available through traditional text and image based user interfaces may be accessed utilizing the audio system management. In one embodiment, the user may parse out content to family members, friends, or paid transcriptionists to create text content from the audio content submitted by the user. Once the audio content is generated it may be indexed and distributed through the cloud network, a distributed network, or a peer-to-peer network. In one embodiment, a central database or communications management system may identify original content that has been converted to audio content by associating a known or assigned identifier. For example, the identifier may be a digital signature or fingerprint of the original content that is uploaded to a cloud based server and database system managed by a communications service provider, non-profit encouraging audio access to content, or a government entity. The received identifiers are archived into an index that may stored centrally or distributed with updates to available content being synchronized and updated. Any number of databases, tables, indexes, or systems for tracking and updating content, associated identifiers, links, original content, and audio content may be utilized.

Next, the audio content may be uploaded to the centralized location. Alternatively, a link to the distributed content may be saved for retrieval from distributed servers, personal computing or communications devices, networks or network resources. Requests for content may be routed to and fulfilled utilizing a centralized or distributed model.

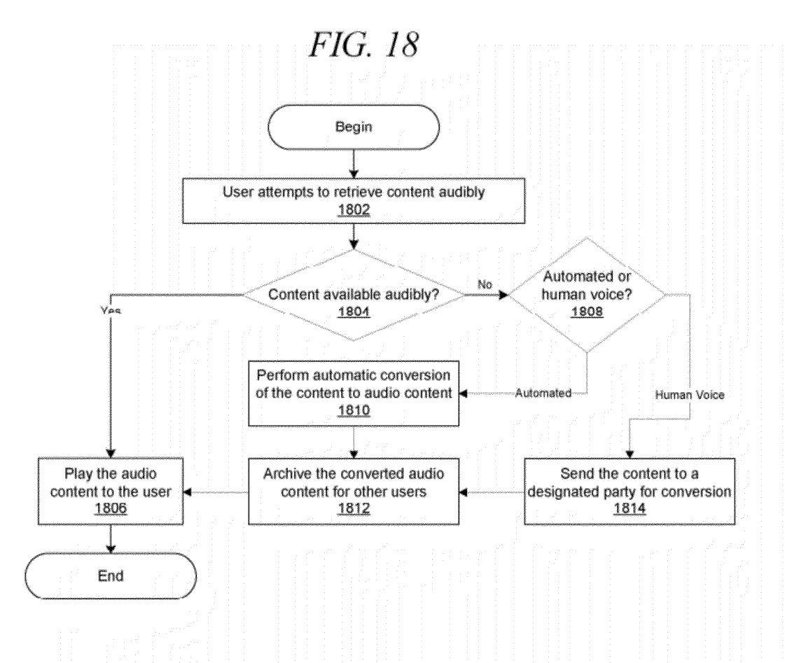

Turning now to the process of FIG. 18, FIG. 18 may be implemented by a computing or communications device operable to perform audio conversion of original content. The process of FIG. 18 may be performed with or without user interaction or feedback prompted by an electronic device. The process may begin with a user attempting to retrieve content audibly (step 1802). In one embodiment, the content may be from a social network the user is utilizing or reviewing. In another embodiment, the content is available through an eReader or web pad (i.e. iPad).

Next, the system determines whether the content is available audibly (step 1804). If the content is available audibly, the system plays the audio content to the user (step 1806). The system may determine whether the content is available audibly by searching archived content, databases, memory, cables, websites, links and other indicators or storage locations. If the system determines the content is not available audibly during step 1804, the system determines whether to utilize an automated or human voice (step 1808). The determination of step 1808 may be performed based on user preferences that are pre-established.

In another embodiment, at the time of selection of audio content, such as step 1802, the user may indicate whether he or she wants to hear the content with a human voice or an automated voice. In some cases different users may have a preference for an automated or human voice based on the conversion time required, ease of understanding the voice and other similar preferences or characteristics. If the system determines to utilize an automated voice during step 1808 the system performs automatic conversion of the content to audio content (step 1810). The conversion process is previously described and may be implemented as soon as possible for immediate utilization by the user.

Next, the system archives the converted audio content for other users (step 1812) before continuing to play the audio content to the user (step 1806). By archiving the converted audio content for other users, audio processing resources are conserved and audio content that may be retrieved by one user is more easily retrieved by any number of other users that subsequently select to retrieve the content. As a result, the audio content may be played more quickly to the user and the conversion process does not need to be performed redundantly to the extent the converted content may be communicated between distinct systems, devices and software.

If the system determines to utilize a human voice in step 1808, the system sends the content to a designated party for conversion (step 1814). The designated party may be one or more contractors or volunteers, conversion centers or other resources or processes that utilize individuals to read aloud the content. Next, the system archives the converted audio content for other users (step 1812) and plays the audio content to the user (step 1806) with the process terminating thereafter.

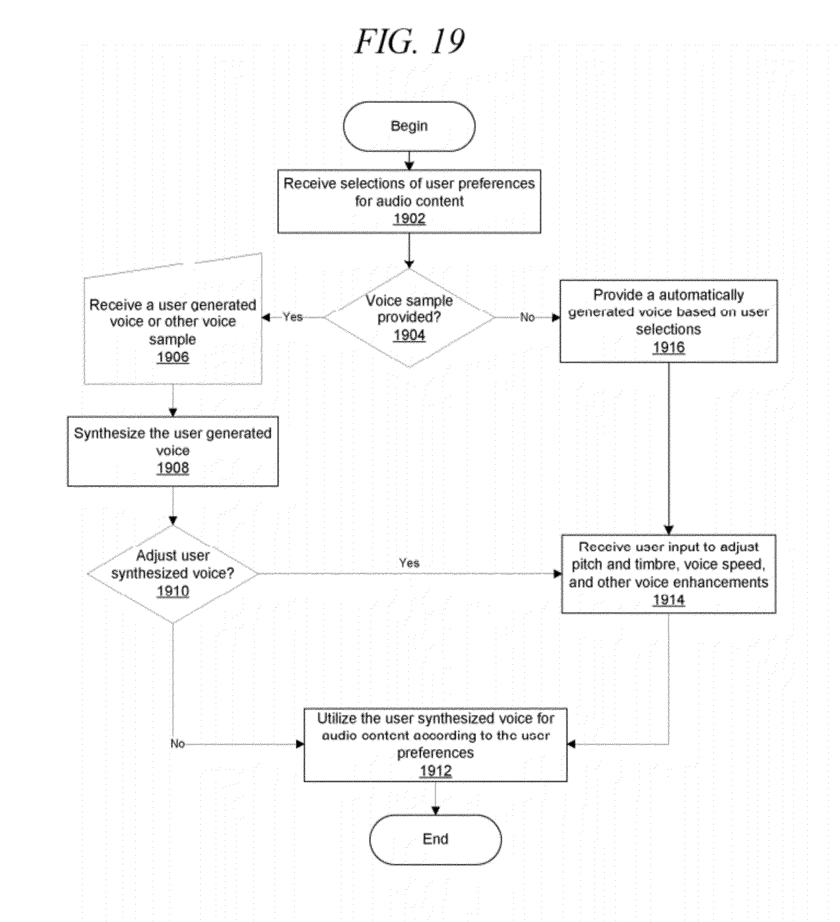

Turning now to the process of FIG. 19. The process of FIG. 19 may similarly be performed by a computing or communications device enabled for audio conversion or by other electronic devices as described herein. The process may begin by receiving selections of user preferences for audio content (step 1902). The user preferences may include any number of characteristics, factors, conditions or settings for generation or playback of audio content. For example, the user may speak quite slowly and may prefer that when a user generated voice is utilized that it be sped up to one and a half times normal speed. In other embodiments, the user may prefer that his or her voice not be recognizable and as a result may specify characteristics such as pitch, volume, speed or other factors to ensure that the user's voice is not recognizable.

Next, the system determines whether a voice sample will be provided (step 1904). The system may interact with a user to make the determination of step 1904. If the system determines that a voice sample will be provided in step 1904, the system receives a user generated voice or other voice sample (step 1906). In one embodiment, the system may prompt a user to speak a designated sentence, paragraph or specific content. As a result, the system may be able to analyze the voice characteristics of the voice sample for generating audio content. Next, the system synthesizes the user generated voice (step 1908). During step 1908, the system completes all the processing required and generates a synthesized equivalent or approximation of the user's voice that may be utilized for social networking posts, a global positioning system, communications through a wireless device and other audio content that is generated by or associated with the user.

Next, the system determines whether to adjust the user synthesized voice (step 1910). Adjustments may occur based on determinations that the voice sample and the synthesized user voice are not similar enough or based on user feedback. For example, the user may simply determine that the voice is too similar or not similar enough to the voice sample provided and as a result the user may be able to provide customized feedback or adjustments to the synthesized voice. Next, if the system determines not to adjust the user synthesized voice in step 1910, the system utilizes the user synthesized voice for audio content according to the user preferences (step 1912).

If the system determines to adjust the user synthesized voice in step 1910, the system receives user input to adjust pitch and timbre, voice speed and other voice characteristics (step 1912). The adjustments of step 1912 may be performed until the user is satisfied with the sound and characteristics of the voice. For example, the user may be able to select sentences or textual input that is converted to audio content and played with the user synthesized voice to ensure that he or she is satisfied with the sound and voice characteristics of the synthesized voice. If the system determines a voice sample is not provided in step 1904, the system may provide an automatically generated voice based on user selections (step 1916). For example, the user may be prompted to select a male or female voice as a starting point. The system may then receive user input to adjust pitch and timbre, voice speed and other voice characteristics in step 1914.

Next, the system utilizes the user synthesized voice for audio content according to the user preferences (step 1912). As a result, during the process of FIG. 19, the user may select to utilize his or her own voice as a starting point or may utilize a computer generated or automatic voice for adjustments to generate a voice that will be associated with the user. In one embodiment, the user preferences may indicate specific websites, profiles or other settings for which the voices or voice generated during the process of FIG. 19 may be utilized.

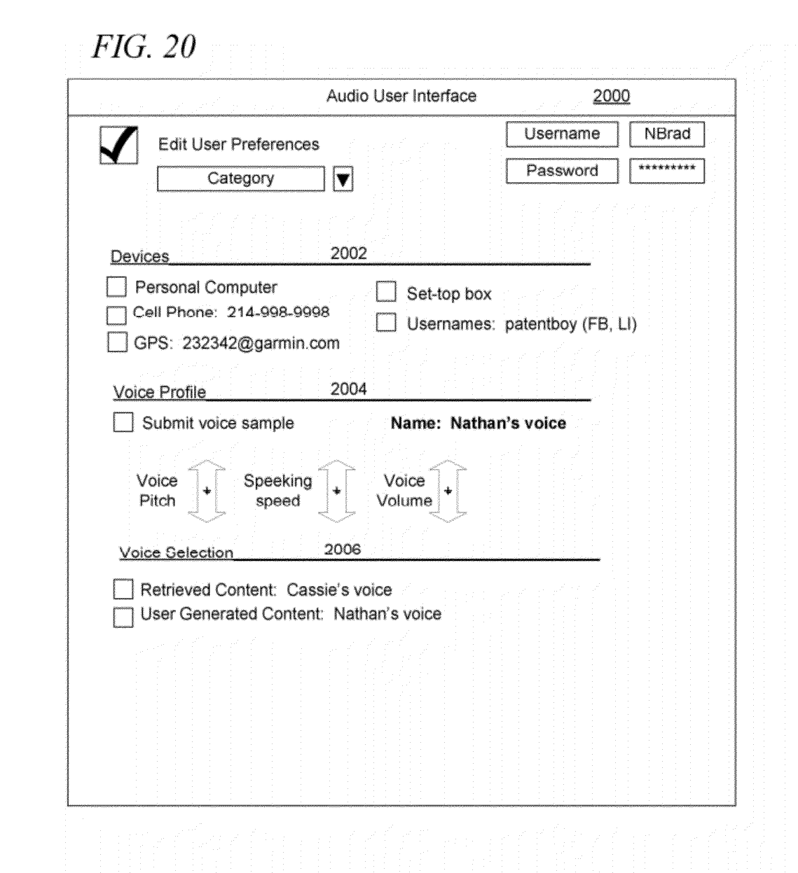

Turning now to FIG. 20, FIG. 20 illustrates one embodiment of an audio user interface 2000. In one embodiment, the audio user interface may be utilized with any of the processes herein described. For example, the audio user interface 2000 may be utilized with the process of FIG. 19 to generate or adjust a voice. In one embodiment, the audio user interface 2000 may include any number of selection elements or indicators for providing user input and making selections. I

In one embodiment, the user may be required to provide a user name and password for securing the information accessible through the other user interface 2000. The user may select to edit the user preferences utilizing the audio user interface 2000. The user preferences may be specified for any number of devices as shown in section 2002. For example, the audio user interface 2000 may be utilized to adjust user preferences and voices utilized for a personal computer, cell phone, GPS, set-top box, social networking site associated with a username, web pad, electronic reader or other electronic device with which the user may generate or retrieve audio content.

Section 2004 may be utilized to generate a default user voice or user synthesized voice as previously described in FIG. 19. The audio user interface 2000 may be utilized to create any number of distinct voices that are utilized with different devices or applications. For example, the user may have one voice that is utilized for work applications and another voice that is utilized for social applications. The appropriateness or selection of each voice may be left to the user based on his or her own preferences.

In section 2006, the user may select from any number of voices that have been automatically generated or synthesized based on input provided by the user for use by the distinct devices and applications. In one embodiment, the audio user interface 2000 may be utilized or managed by a single individual or administrator for a number of different devices or users. For example, a parent may specify the voices that are utilized for each of their children's devices and how and when those voices are utilized. For example, a program that reads text from the parent may utilize the parent's voice to play back those text messages to make the messages seem more realistic and perhaps even more understandable to the children.

While there has been illustrated and described embodiments consistent with the present invention, it will be understood by those skilled in the art that various changes and modifications may be made and equivalents may be substituted for elements thereof without departing from the true scope of the invention. Therefore, it is intended that this invention not be limited to the particular embodiments disclosed.

What is claimed:

1. A method for distributing audio content, the method comprising:
receiving a user selection of original content, the user selection indicating a user wants the original content to be converted to audio content;
converting the original content to the audio content;
associating an identifier with the original content and the audio content; and
storing the identifier and the associated audio content in a network device for access by one or more users that select to listen to the original content.

2. The method according to claim 1, further comprising indexing identifiers associated with each of a plurality audio files converted from a plurality of original files, wherein the index is available to a plurality of users through a network connection.

3. The method according to claim 2, further comprising distributing the index to a plurality of network access points in response to indexing identifiers.

4. The method according to claim 1, wherein the converting comprises sending the original content to a transcriptionist to generate the audio content from the original content.

5. The method according to claim 4, wherein the transcriptionist if a family member or friend.

6. The method according to claim 1, further comprising:
receiving a user selection from a secondary user for the original content;
accessing the index to determine the identifier associated with the original content and the audio content in response to the receiving the user selection;
retrieving the audio content associated with the identifier for playback to the secondary user.

7. The method according to claim 1, wherein the index associating a plurality of identifiers and a plurality of audio files are stored in a plurality of locations for distributed access by users.

8. The method according to claim 7, wherein the index associating each of the plurality of identifiers and the plurality of audio files is stored in a cloud network.

9. A system for performing distributing audio content, the system comprising
a plurality of user devices enabled for communication with a cloud network, wherein one the plurality of user devices receive a user selection of original content, the user selection indicating a user wants the original content to be converted to audio content, the one of the plurality of user devices manage conversion of the original content to the audio content; and
the cloud network operable to associate an identifier with the original content and the audio content, wherein the cloud network stores the identifier and the associated audio content for access by one or more users that select to listen to the original content.

10. The system according to claim 9, wherein the plurality of user devices perform automatic text-to-voice conversion to generate the audio content.

11. The system according to claim 9, wherein the plurality of user devices send the original content to a designated party to convert the original content to the audio content.

12. The system according to claim 11, wherein the designated party utilizes a human voice to generate the audio content utilizing a hierarchy of the original content.

13. The system according to claim 9, wherein the cloud network stores an index associating each of a plurality of identifiers associated with each of a plurality audio files converted from a plurality of original files, wherein the index is available to the plurality of user devices through a network connection.

14. The system according to claim 9, wherein the audio content is retrieved by one of the plurality of user devices

15. A network device comprising:
a processor for executing a set of instructions; and
a memory for storing the set of instructions, wherein the set of instructions are executed by the processor to:
receive a user selection of original content, the user selection indicating a user wants the original content to be converted to audio content;
converting the original content to the audio content;
associating an identifier with the original content and the audio content; and
storing the identifier and the associated audio content for access by one or more users that select to listen to the original content.

16. The network device according to claim 15, wherein the set of instructions are further executed to index identifiers associated with each of a plurality audio files converted from a plurality of original files, wherein the index is available to a plurality of users through a network connection.

17. The network device according to claim 15, wherein the set of instructions are further executed to distribute the index to a plurality of network access points in response to indexing identifiers.

18. The network device according to claim 15, wherein the set of instructions are further executed to send the original content to a transcriptionist to generate the audio content from the original content.

19. The network device according to claim 18, wherein the set of instructions are further executed to:
receive a user selection from a secondary user for the original content;
access the index to determine the identifier associated with the original content and the audio content in response to the receiving the user selection;
retrieve the audio content associated with the identifier for playback to the secondary user.

20. The network device according to claim 15, wherein the index associating a plurality of identifiers and a plurality of audio files are stored in a plurality of locations for distributed access by users

21. A method of providing audio content for social networking, the method comprising:
prompting a user to select a voice;
adjusting a voice pitch, speaking speed, and volume of the voice in response to user input;
associating one or more voices including the voice with social networking content generated by the user in response to user preferences; and
audibly communicating the social networking content utilizing the voice in response to selection of the social networking content.

22. The method according to claim 21, wherein the voice includes an automated voice or synthesized voice.

23. The method according to claim 22, further comprising:
recording a voice sample;
generating the synthesized voice utilizing the voice sample to approximate the voice sample of the user; and
utilizing the synthesized voice as the voice.

24. The method according to claim 21, wherein the prompting further comprises generating a plurality of voices for associating with each of a plurality of social networks according to the user preferences.

25. The method according to claim 21, wherein the adjustments to the voice pitch include timbre.

26. The method according to claim 21, wherein the social networking content includes comments made by the user online.

27. The method according to claim 21, wherein the audibly communicating comprises playing back the social networking content to any of a plurality of users access the social networking content.

28. The method according to claim 21, further comprising storing the social networking content and the voice as an audio file for playback in response to the selection.

29. A system for providing associating a voice with a user, the system comprising:
a plurality of devices enabled for communication with a cloud network, wherein one of the plurality of devices prompting a user to select a voice, and adjust a voice pitch and timbre, speaking speed, and volume of the voice in response to user input;
the cloud network operable to associate one or more voices including the voice with social networking content generated by the user in response to user preferences, and playback the social networking content utilizing the voice in response to selection of the social networking content.

30. The system according to claim 29, wherein the voice is an automatic voice generated utilizing text-to-voice conversion.

31. The system according to claim 29, wherein the plurality of devices are further operable to:
record a voice sample; and
generate the synthesized voice utilizing the voice sample to approximate the voice sample of the user.

32. The system according to claim 29, wherein the social networking content includes comments made by the user online.

33. The system according to claim 29, wherein the cloud network stores the social networking content and the voice as an audio file for playback in response to the selection.

34. The system according to claim 29, wherein the user generates a plurality of voices for associating with each of a plurality of social networks according to the user preferences stored in one or more devices.

35. A network device comprising:
a processor for executing a set of instructions; and
a memory for storing the set of instructions, wherein the set of instructions are executed by the processor to:
prompt a user to select a voice;
adjusting a voice pitch, speaking speed, and volume of the voice in response to user input;
associating one or more voices including the voice with social networking content generated by the user in response to user preferences; and
audibly communicating the social networking content utilizing the voice in response to selection of the social networking content.

36. The network device according to claim 35, wherein the set of instructions are further executed to store the social networking content and the voice as an audio file for playback in response to the selection.

37. The network device according to claim 35, wherein the social networking content includes comments made by the user online.

38. The network device according to claim 35, wherein the set of instructions are further executed to generate a plurality of voices for associating with each of a plurality of social networks, a plurality of websites, a plurality of profiles, or a plurality of electronic devices according to the user preferences.

39. The network device according to claim 35, wherein the voice includes an automated voice or synthesized voice.

40. The network device according to claim 35, wherein the set of instructions are further executed to:
record a voice sample;
generate the synthesized voice utilizing the voice sample to approximate the voice sample of the user; and
utilize the synthesized voice as the voice.
